(19) United States
(12) Patent Application Publication
(10) Pub. No.: US 2015/0253930 A1
(43) Pub. Date: Sep. 10, 2015

(54) TOUCHSCREEN FOR INTERFACING WITH A DISTANT DISPLAY

(71) Applicant: INTERNATIONAL BUSINESS MACHINES CORPORATION, Armonk, NY (US)

(72) Inventors: James R. KOZLOSKI, New Fairfield, CT (US); Clifford A. PICKOVER, Yorktown Heights, NY (US)

(73) Assignee: INTERNATIONAL BUSINESS MACHINES CORPORATION, Armonk, NY (US)

(21) Appl. No.: 14/202,742

(22) Filed: Mar. 10, 2014

(51) Int. Cl. G06F 3/042; G06F 3/0488; G06F 3/0484; G06F 3/0481

(52) U.S. Cl. CPC G06F 3/0425; G06F 3/04817; G06F 3/04883; G06F 3/04842; G06F 2203/04807

(57) ABSTRACT

A portable device having a transparent touchscreen enables a more natural user interface by an observer interfacing with a distant display. A line-of-sight is established from the observer through the transparent touchscreen and to the distant display. In response to the observer touching the transparent touchscreen at a location where an icon on the distant display is perceived, a process is initiated related to the distant display. The distant display may be any type of display from a non-interactive printed poster or a television or movie theater screen to an interactive computer display. The transparent touchscreen may include integrated transparent display elements.

### BACKGROUND

This disclosure broadly relates to the field of touchscreen input systems, and more particularly to the field of a touchscreen for interfacing with a distant display.

Touchscreen based user interfaces are found on many computerized devices including cellphones, laptops, kiosks, and computerized games. An observer sees an image on a display and touches a touchscreen integral to the display to initiate a process associated with the image. For example, on a cellphone, an image of a numeric telephone keypad may be rendered on a display, and an observer touches the images of the keys to dial a phone number. The touch inputs are received at a touchscreen and based upon a dimensionally fixed relationship between the touchscreen and the display established at time of manufacturing, the touch inputs are transformed into signals corresponding to each numeric key in order to dial the phone number.

However, touchscreens in public places can present an unsanitary user interface, Dirt, debris and even pathogens may accumulate on the surface of the touchscreen from its use by multiple users. Also, the touchscreen and the corresponding display are required to be within arm's length. Thus, the touchscreen user input paradigm, for all of its convenience and intuitive user input characteristics, is not conducive to either sanitary applications or or use with displays which are located a distance from an observer of the display.

### SUMMARY

Briefly, in an aspect of the disclosure, a line-of-sight is established from an observer, through a transparent touchscreen, and to a distant display. The observer touches the transparent touchscreen at locations corresponding to locations on the distant display, based upon the line-of-sight between the observer and the distant display. The transparent touchscreen transforms the touch inputs to signals that correspond to locations on the distant display and transmits the signals or otherwise initiates a distant display related process. The transparent touchscreen may be a portable handheld device. The distant display may be any of several devices including an interactive device such as a personal computer, an active display device such as a television or movie theater screen, or even a passive non-interactive display such as a printed sign or billboard. The transparent touchscreen provides the benefit of the intuitive touchscreen user interface for use with displays in public places, while preserving the sanitary aspects of a privately held portable touchscreen device. Furthermore, this also provides for the intuitive touchscreen interface for use with distant displays that are located beyond arm's length.

An aspect of the disclosure includes a method comprising: determining a line-of-sight between an observer and a distant display to pass through a device having a transparent touchscreen; determining a distant display zone on the transparent touchscreen based upon the line-of-sight; and initiating a distant display related process based upon a touch input being received within the distant display zone. The initiated process comprises transmitting a touch signal indicative of the touch input. The initiated process comprises: transforming a transparent touchscreen coordinate of the touch input to a distant display coordinate based upon the distant display zone; and transmitting a touch signal indicative of the distant display coordinate. The distant display includes an array of pixels for rendering a rendered image, the array of pixels having a corresponding array of pixel coordinates on the distant display and further wherein the transforming, further based upon the array of pixel coordinates, transforms the transparent touchscreen coordinate to the distant display coordinate, the distant display coordinate including an at least one pixel coordinate of the array of pixel coordinates. The method according to further comprising receiving a pixel array signal indicative of the array of pixel coordinates. The distant display includes an icon image positioned at an icon image location on the distant display and further wherein the determining the distant display zone determines an icon image zone based the icon image location, the initiating initiates the distant display related process based upon the touch input being received within the icon image zone, and the initiated process includes transmitting a touch signal indicative of the icon image. The method further comprises receiving an icon image signal indicative of the icon image location on the distant display. The method according to claim 6 further comprises receiving, from a forward camera affixed to the device, a forward image including the icon image; and determining the icon image location based upon the forward image. The method further comprising, the identification of the distant display from a set of distant displays, each of which broadcasts an icon image signal, wherein the identification comprises matching an icon image signal to the forward image. The method further comprising: receiving, from a forward camera affixed to the device, a forward image including a distant display image; and receiving, from a rearward camera affixed to the device, a rearward image including an observer image, wherein the line-of-sign is determined based upon the forward image and the rearward image. The method further comprising: determining a distant display location; and determining an observer location, wherein the line-of-sight is determined based upon the distant display location and the observer location. The touch input includes a motion gesture (or motion gesture), the initiating initiates the distant display related process based upon the motion gesture being at least partially received within the distant display zone, and the initiated process includes transforming a transparent touchscreen coordinate set of the motion gesture to a distant display coordinate set based upon the distant display zone; and transmitting a touch signal indicative of the distant display coordinate set. The method further comprising: rendering, at the distant display, an unlocking image for entering an image based gesture password for unlocking additional functionality of the distant display, the observer able to perceive the line-of-sight view of the unlocking image through the transparent touchscreen, and unlocking, at the distant display, the additional functionality based upon the transformed distant display coordinate set corresponding to the image based gesture password. The determined distant zone display area on the transparent touchscreen is preserved upon the line-of-sight in no longer being determined.

An aspect of the disclosure includes a device comprising: a transparent touchscreen configured to receive a touch input; an observer locator configured to determine an observer location; a distant display locator configured to determine a distant display location; a line-of-sight determining module configured to, based upon the observer location and the distant display location, determine that a line-of-sight between the observer location and the distant display location passes through the transparent touchscreen; a distant display zone module configured to determine a distant display zone on the transparent touchscreen based upon the line-of-sight; and a controller configured to initiate a distant display related process based upon the touch input being received within the distant display zone. The distant display locator includes a forward camera affixed to the device, the forward camera receiving a forward image including a distant display image wherein the distant display location is determined based upon the forward image, the observer locator includes a rearward camera affixed to the device, the rearward camera receiving a rearward image including an observer image wherein the observer location is determined based upon the rearward image, the device further comprising: a coordinate transformation module configured to transform a transparent touchscreen coordinate of the touch input to a distant display coordinate based upon the distant display zone; and a transmitter configured to transmit a touch signal indicative of the distant display coordinate. The distant display image includes an array of pixels for rendering a rendered image, the array of pixels having a corresponding array of pixel coordinates on the distant display, the device further comprising a receiver configured to receive a pixel array signal indicative of the array of pixel coordinates, and further wherein the coordinate transformation module is configured to transform the transparent touchscreen coordinate of the touch input to the distant display coordinate, the distant display coordinate including an at least one pixel coordinate of the array of pixel coordinates. The touch input includes a motion gesture having a transparent touchscreen coordinate set upon the transparent touchscreen, and the coordinate transformation module is configured to transform the transparent touchscreen coordinate set of the touch input to a distant display coordinate set based upon the distant display zone, and the transmitter is configured to transmit the touch signal indicative of the distant display coordinate set. The distant display may be one of multiple distant displays visible through the transparent touchscreen, and the device is configured to determine multiple distant display zones based on the multiple distant displays, transform the touch input a distant display coordinate corresponding to the distant display zone receiving the touch input, select a distant display from the multiple distant displays for transmission of the distant display signal.

An aspect of the invention includes a computer program product comprising: a storage medium readable by a processing circuit and storing instructions for execution by the processing circuit configured to perform a method comprising: determining a line-of-sight between an observer and a distant display to pass through a device having a transparent touchscreen; determining a distant display zone on the transparent touchscreen based upon the line-of-sight; initiating a distant display related process based upon a touch input being received within the distant display zone. The method further comprises: transforming a transparent touchscreen coordinate of the touch input to a distant display coordinate based upon the distant display zone; and transmitting a touch signal indicative of the distant display coordinate. The method further comprises: receiving, from a forward camera affixed to the device, a forward image including a distant display image; and receiving, from a rearward camera affixed to the device, a rearward image including an observer image, wherein the line-of-sign is determined based upon the forward image and the rearward image.

### BRIEF DESCRIPTION OF THE DRAWINGS

The accompanying figures where like reference numerals refer to identical or functionally similar elements throughout the separate views, and which together with the detailed description below are incorporated in and form part of the specification, serve to further illustrate various embodiments and to explain various principles and advantages all in accordance with the present disclosure, in which:

FIG. 1 illustrates a cross-sectional diagram of a transparent touchscreen device being used to interface with a non-interactive distant display;

FIG. 2 illustrates a cross-sectional diagram of a transparent touchscreen device being used to interface with an interactive distant display;

FIG. 3 illustrates an example of a distant display having a rendered image and a corresponding distant display coordinate system;

FIG. 4 illustrates a line-of-sight perspective from an eye of the observer through the transparent touchscreen to the distant display of FIG. 3;

FIG. 5 illustrates an example block diagram of a transparent touchscreen device;

FIG. 6 illustrates an example of a flow diagram for a transparent touchscreen device operating with a non-interactive distant display;

FIG. 7 illustrates an example of a flow diagram for a transparent touchscreen device operating with an interactive distant display using transformed distant display coordinates; and

FIG. 8 illustrates an example of a flow diagram for a transparent touchscreen device operating with an interactive distant display using pixel array distant display coordinates.

### DETAILED DESCRIPTION

In the following discussion, details are provided to help thoroughly understand the present disclosure. However, it is apparent to those of ordinary skill in the art that even though there may be no such details, the understanding of the present disclosure would not be influenced. In addition, it should be further appreciated that any specific terms or applications used herein are only for the convenience of description, and thus the present disclosure should not be limited to only use in any specific terms or applications represented and/or implied by such terms.

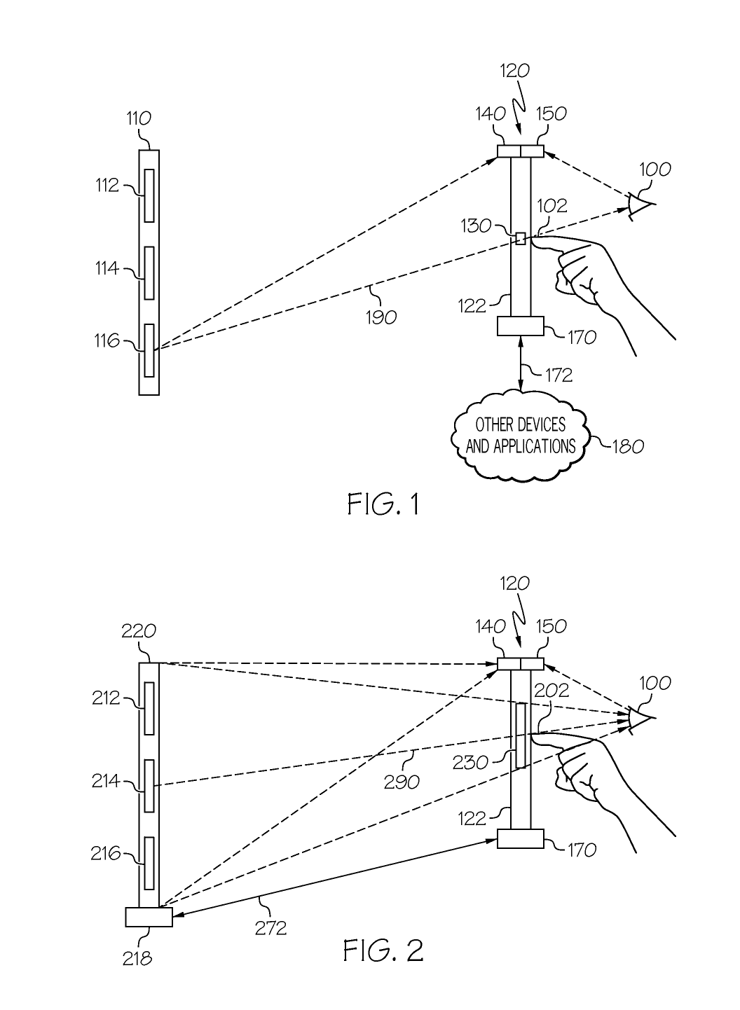

FIG. 1 illustrates a cross-sectional diagram of a transparent touchscreen device being used to interface with a non-interactive distant display. The eye of an observer 100 is shown viewing a non-interactive distant display 110. The non-interactive distant display may be a sign, poster, billboard, computer monitor, television, movie theater screen or other display where the distant display 110 does not directly interact with the transparent touchscreen device 120. Distant display 110 includes one or more icon images 112, 114 and 116 which may be used for interfacing with other devices or applications 180. For example, icon 116 may be a barcode or Quick Response (CR) code that may contain information including a Universal Resource Locator (URL). The URL may be used for providing additional information associated with displayed information available from server devices operating applications. Other such devices and applications 180 may interface with the transparent touchscreen device 120 through a connection 172 to the Internet or other network.

Distant display 110 is viewed by the eye of the observer 100 through a transparent touchscreen device 120. The transparent touchscreen device includes a transparent touchscreen 122 that appears as a clear solid material similar to a pane of glass. The transparent touchscreen is configured to determine touch coordinates of a touch input. The transparent touchscreen may determine single or multiple touch inputs as well as gesture inputs. The construction and operation of touchscreens are known to those familiar to the art as they are commonly integrated with displays in applications such as cellphones, tablets and laptops. In this example, transparent touchscreen 122 is not affixed to a display and may be configured to receive touch inputs on both the front side and the back side surfaces.

In one example of its use, the observer is holding the transparent touchscreen device in one hand in such a way that a line-of-sight 190 is established from the observer through the transparent touchscreen 122 and to icon image 116. In operation a finger 102 of the observer touches the transparent touchscreen at a location where the icon is perceived by the observer based upon the line-of-sight. Note that in other examples, a stylus or other device may be made to make touch inputs on the transparent touchscreen in place of the observer's finger 102. The transparent touchscreen device determines the line-of-sight by determining the location of the observer and the location the icon image of the distant display relative to the transparent touchscreen. The transparent touchscreen device then determines if the touch input is received on the transparent touchscreen at a location that corresponds to an icon image zone/distant display zone 130 on the transparent touchscreen, the icon image zone corresponding to an area where the line-of-sight passes through the transparent touchscreen. If so, then a subsequent process related to distant display may be initiated.

For example if the icon image is a QR code, then the transparent touchscreen device could process an image of the QR code, extract the URL and initiate an email with the URL addressed to the observer. The transparent touchscreen device will then connect to the Internet or other network through a transceiver 170 having a WiFi, Bluetooth or other wireless or wired interface 172 and send the email. Upon reception, the email would remind the observer to subsequently follow-up on the information observed on the distant display. In another example the icon image could further be a “buy it now” icon image, the icon image having metadata (within a QR code or other approach) describing the goods or services being purchased as well as information for completing an Internet based purchase transaction. The transparent display device would add payment and customer information to complete the transaction. In this example, an observer sees a billboard or poster advertising goods or services, and after reviewing the terms, holds the transparent touchscreen device to view the “buy-it-now” icon image through the transparent touchscreen, and then touches the touchscreen where the line-of-sight to the icon image passes through the transparent touchscreen. This then initiates a process for completing the transaction. In both of these examples, the transactions are completed without the observer touching the distant display and without requiring the observer to be within arm's length of the distant display.

The location of the icon image on the distant display may be determined by any approach while remaining within the scope of the description. In this example, the transparent touchscreen device has a distant display locator 140 which determines spherical coordinates (the polar angle, the azimuth angle, and the distance) of the icon image on the distant display relative to the transparent display device. This may be accomplished with triangulation using an array of forward cameras. In another example, a single forward camera may determine the polar and azimuth angles while a range finding approach may determine the distance. Such range finding approaches include camera focus fields, as well as ultrasonic and radio frequency detection and ranging (RADAR) approaches known to those familiar with the art. In another example, the distant display may have a known global positioning system (GPS) location which may be compared with a determined GPS location of the transparent touchscreen device in order to determine the distance. The transparent touchscreen and distant display may also include combinations of these technologies which are applied together or in a context dependent manner to determine the location of the distant display. The forward image received by the camera or camera array includes the distant display image which may include the rendered image which may comprise of an array of pixels having pixel coordinates and/or the icon image. The forward image is processed to determine its location and any metadata associated therewith. The forward image is processed using image processing approaches such as object recognition, pattern recognition, and character recognition to extract and interpret information associated with the icon image. Any form of image processing is considered to be within the scope of this description including image processing techniques known to those familiar with the art.

Similarly, the location of the eye of the observer may be determined by any approach while remaining within the scope of the description. In this example, the transparent touchscreen device has an observer locator 150 which determines spherical coordinates (the polar angle, the azimuth angle and the distance) of the eye of the observer relative to the transparent display device. This may be accomplished with triangulation using an array of rearward cameras; alternately a single rearward camera may determine the polar and azimuth angles while a range finding approach may determine the distance. Such range finding approaches include camera focus fields, as well as ultrasonic and radio frequency detection and ranging (RADAR) approaches known to those familiar with the art. The rearward image received by the rearward camera or camera array includes the observer image which includes the eye of the observer image which is processed to determine the location of the eye of the observer. In the case where the observer has an additional eye, one of the eyes can be preselected as a preferred or “stronger” eye for the purposes of locating the eye of the observer. The rearward image is processed using image processing approaches such as facial recognition and eye recognition to determine the location of the eye of the observer.

The distant icon image zone of the display zone corresponding to the icon image is determined by determining the location of the icon image in the distant display and the location of the eye of the observer relative to the transparent display device. In the above example, the spherical coordinates of the icon image and spherical coordinates of the eye of the observer are determined using forward and rearward cameras fixed to the transparent display device which also includes the transparent display affixed thereto. Since the location of the forward and rearward cameras are fixed relative to the transparent touchscreen, it can be determined that the line-of-sight between the eye and the icon passes through transparent touchscreen. Furthermore, the icon image zone is established on the transparent display in an area where the line-of-sight passes through the transparent touchscreen. The area if the icon image zone on the transparent touchscreen is substantially equal to the area of the icon image as perceived by the observer. This has the benefit of facilitating the natural user interface experience of a touchscreen enabled laptop, tablet or cellphone even though the display associated with the touchscreen may be a great distance away from the observer.

FIG. 1 illustrates the icon image zone/distant display zone 130 being located substantially in the middle of the cross section of the transparent touchscreen 122 based upon a location where the line-of-sight 190 between the icon image 116 and the eye of the observer 100 passes through the transparent touchscreen 122.

It should further be appreciated that while one icon image zone/distant display zone 130 corresponding to one icon image 116 is shown for clarity of example, multiple icon image zones/distant display zones may be determined for the transparent touchscreen corresponding to multiple icons 112, 114, and 116 of the distant display using the techniques described above. A touch input on each distant display zone may result in initiation of different processes related to the distant display being initiated. For example, icon image 112 may indicate that additional information is available on an advertised product on distant display 110, and a touch input received at an icon image zone relating to icon image 112 may initiate a process resulting in an email being sent to the observer with the additional information. Icon image 114 may indicate that additional information is available on products similar to the advertised product on distant display 110, and a touch input received at an icon image zone/distant display zone relating to icon image 114 may initiate a process that results in an email to the observer with additional information on the similar products. Icon image 116 may indicate that the product advertised product on distant display 110 is available for purchase, and a touch input received at icon image zone/distant display zone 130 relating to icon image 116 may initiate a transaction resulting in a purchase and shipping of the advertised product to the observer. Furthermore, icons 112-116 need not be contained within a single display 110. For example icon 112 may be rendered on a video display monitor while icon 116 may be included within a printed poster board separate from the video display monitor while both icons may be simultaneously visible to the observer through the transparent display 122.

FIG. 2 illustrates a cross-section diagram of a transparent touchscreen device being used to interface with an interactive distant display. The distant display is interactive with the touchscreen because, unlike a printed poster or billboard of the non-interactive distant display, the interactive distant display is in communication with the transparent touchscreen and may be responsive to touch inputs received on the transparent touchscreen. The distant display may be similar to a computer screen, tablet, cellphone or kiosk screen and may itself include a touchscreen, track pad, keyboard, mouse and/or other user interface device able to be used by those within arm's length. In such an example, the transparent touchscreen device may act as an additional user interface device that may be operated at a distance greater than an arm's length from the display.

Interactive distant display 220 is rendering icon images 212, 214 and 216 and has a transceiver module 218 adapted to interface with transparent transceiver 170 of transparent touchscreen device 120 through a wireless or wired interface link 272 such as a WiFi, Bluetooth, Ethernet, Universal Serial Bus (USB), or other device to device interface.

Distant display locator 140 locates the distant display as previously described, observer locator 150 locates an observer eye as previously described, and the line-of-sight 290 is determined to be through transparent touchscreen 122 as previously described. In this example, distant display zone 230 is determined to have an area on the transparent touchscreen corresponding to the area of the distant display as perceived by the observer. Thus each corner of distant display zone 230 corresponds to a corner of the distant display as perceived by the observer. When a touch input 202 is received on the transparent touchscreen 122, its coordinates on the transparent touchscreen are determined and then transformed to distant display coordinates based upon the determined distant display zone 230. The distant display coordinates are then transmitted to the distant display through transceiver 170 and interface link 272. If the distant display 220 also includes a touchscreen affixed thereto, the response to the distant display coordinates may correspond to a touch being received at the touchscreen of the distant display, even though the observer may be well beyond arm's length of the distant display. Note that the touch input received on transparent touchscreen 122 may be a single touch, a multiple touch input and/or a gesture input. All of which are transformed from coordinates on the transparent touchscreen to distant display coordinates based upon the distant display zone established by the determined line-of-sight 290.

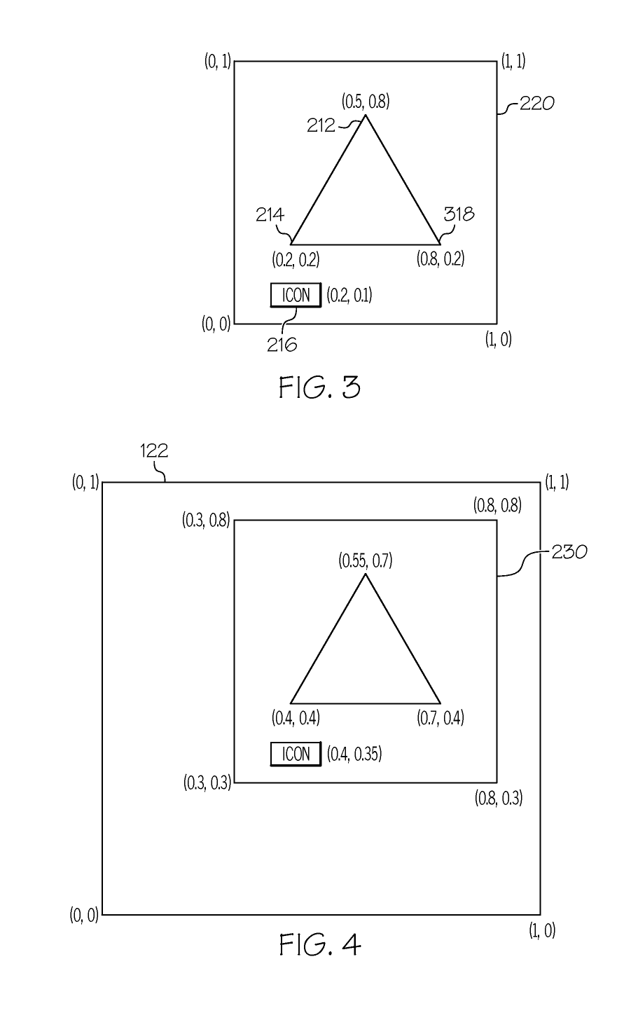

FIG. 3 illustrates an example of a distant display having a rendered image and a corresponding distant display coordinate system. Distant display 220 is shown as a square display in this example and has a transformed coordinate system that begins at (0, 0) in the lower left corner of the display. The upper left corner has a coordinate of (0, 1) the lower right corner has a coordinate of (1, 0) and the upper right corner has a coordinate of (1, 1). Rendered on the display is a figure of a triangle having a lower left corner at distant display coordinate (0.2, 0.2), corresponding to icon image 214, an upper corner at coordinate (0.5, 0.8), corresponding to icon image 216, and a lower right corner at distant display coordinate (0.8, 0.2), 318. Distant display 220 is also rendering icon image 216 centered at distant display coordinate (0.2, 0.1). While icons associated with distant display coordinates are shown as a point for clarity of illustration, those familiar with the art will appreciated that the distant display coordinates may represent an area larger than the point coordinate illustrated in this example.

In this example, the triangle represents an unlocking image where the entry of an image gesture password based upon the unlocking image unlocks the distant display and enables additional functionality. If the distant display in this example includes an integral touchscreen and is included within a personal computer system, then a user within arm's length of the distant display may unlock the personal computer system by entering the image gesture password at the touchscreen integrated into the distant display. In this example a touch input gesture made at the distant display beginning at corner 214, traveling up and to the right at corner 212, and then traveling down and to the right to corner 318 produces the correct image gesture password and unlocks additional functionality of the personal computer system.

Also rendered on the distant display 220 of FIG. 3 is icon image 216. In one example, a touch input received at icon image 216 may cause a different unlocking image, such as a square or a star, to be rendered. The different unlocking image would require a different image gesture password to unlock additional functionality of the computer system. While in this example unlocking images and gesture passwords are shown, in other examples, any of numerous other icon images and functionalities may be used while remaining within the scope of this description.

FIG. 4 illustrates a line-of-sight perspective from an eye of the observer through the transparent touchscreen to the distant display of FIG. 3. Transparent touchscreen 122 is shown as a square touchscreen in this example and has a transformed coordinate system that begins at (0, 0) in the lower left corner of the transparent touchscreen. The upper left corner has a coordinate of (0, 1) the lower right corner has a coordinate of (1, 0) and the upper right corner has a coordinate of (1, 1). The observer has a line-of-sight perspective through the transparent touchscreen to the distant display. Based on the location of the distant display and the location of the observer eye and the determined line-of-sight, the distant display zone 230 is determined to have transparent touchscreen coordinates of (0.3, 0.3) in the lower left corner of the transparent touchscreen. The upper left corner has a coordinate of (0.3, 0.8) the lower right corner has a coordinate of (0.8, 0.3) and the upper right corner has a coordinate of (0.8, 0.8). The rendered icon image of the distant display has a transparent touchscreen coordinate of (0.4, 0.35).

Any touch input received within the distant display zone of the transparent touchscreen may result in a transmission of a signal to the distant display. In the simplest example, the transmitted signal may indicate a touch input was received anywhere within the distant display zone and the distant display may initiate a process in response. For example if the distant display is “asleep”, in a power conservation mode, then a touch anywhere within the distant display zone may result in a simple signal that causes the distant display to “wake-up” and begin further processing, such as rendering an unlocking image.

In another example, if the distant display is rendering an image as shown in FIG. 3, then the transparent display device of FIG. 4 transforms transparent touchscreen input coordinates to distant display coordinates. For example if a touch input is received at an observer perceived location of icon 216, the transparent touchscreen coordinate is (0.4, 0.35) and based on the determined distant display zone, the transparent touchscreen coordinate would be transformed to a transformed distant display coordinate of (0.2, 0.1) and transmitted to the distant display. This transformation corresponds to the coordinate of the icon on the distant display. Given the preceding distant display example, in response to receiving a distant display touch input coordinate of (0.2, 0.1) the distant display may then render a different unlocking image.

In another example, if an observer viewing the distant display through the transparent touchscreen device of FIG. 4 makes an unlocking gesture from transparent display coordinate (0.4, 0.4) corresponding to the lower left corner of the triangle, up and to the right to transparent distant display coordinate (0.55, 0.7) corresponding to the upper corner of the triangle, and down and to the right to transparent display coordinate (0.7, 0.4) of the third corner of the triangle. This gesture corresponds to a transparent touchscreen coordinate set. Then the transparent display device transforms the gesture to as a distant display gesture having distant display coordinates of a gesture from (0.2, 0.2) to (0.5, 0.8) to (0.8, 0.2), and transmits the distant gesture display coordinates, as a distant display coordinate set to the distant display. As previously described, the transformation is based upon the determined line-of-sight and the distant display zone on the transparent touchscreen. In the distant display of the preceding example, the computer system incorporating the distant display interprets this gesture included within the distant display coordinates transmitted by the transparent display device as an unlocking gesture and unlocks additional functionality. In this example, the observer having the transparent display device 120 is able to unlock the additional functionality associated with the distant display without having to be within arm's length of the distant display.

In a different example, the distant display coordinates may be transformed to pixel coordinates of the distant display. For example, if the distant display has a pixel array of 1080×1080 pixels for rendering images, then the coordinate transformation module could transform the transformed distant display coordinate above by multiplying both coordinates by 1080 prior to transmission. In this example, the icon having a transformed distant display coordinate of (0.2, 0.1) would have a pixel coordinate of (216, 108). In this example, the pixel coordinate would be transmitted by the transparent touchscreen device. The pixel resolution of the distant display could be transmitted from the distant display to the transparent touchscreen using communication link 272. The above examples show a 1:1 aspect ratio of the distant display. In other examples, the aspect ratio of the distant display may vary and the determined distant display zone varied accordingly. For example, a distant display may have 16:9 aspect ratio and a 1920×1080 pixel array. As a result, the distant display zone on the transparent touchscreen would also have a 16:9 aspect ratio and, if pixel coordinates are used, then transformed values can be multiplied by the pixel array size ratio to determine the pixel coordinate.

Further note that the distant display and the transparent touchscreen are shown to be in parallel and horizontally aligned. If the parallel and/or horizontal relationship changes, compensation processes known to those familiar with the art may be used in order to more accurately produce transformed distant display coordinates.

Furthermore, since only the observer has the line-of-sight perspective of the distant display, others in the vicinity of the observer may have difficulty in determining the image gesture password entered by the observer on the transparent touchscreen because they do not share the same line-of-sight perspective as the observer entering the image gesture password. On the other hand, passwords entered on conventional keyboards or touchscreens with integral displays may be readily observed and determined by any other persons able to view the password entry. However, the transparent touchscreen adds an additional level of security to password entry because even if password entry on the transparent touchscreen is observed by another, the perspective of the distant display is different, thus there is an additional level of ambiguity associated by another observing the password entry on the transparent touchscreen of this description relative to a conventional keyboard or touchscreen display device.

In another example, multiple distant displays may be visible to the observer through the transparent touchscreen. In such an example, the transparent touch screen would identify each of the distant displays, each distant display would have a corresponding distant display zone on the transparent touchscreen, and touch inputs received at a distant display zone would be transformed into the touch signal based upon the distant display zone. Then the appropriate distant display would be selected corresponding to the distant display zone receiving the touch input. The transparent touchscreen would then transmit touch signal to the selected distant display.

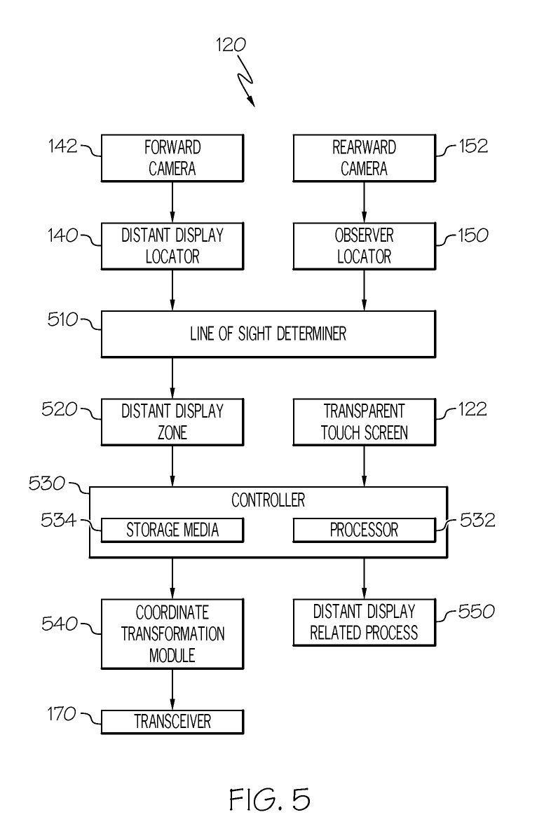

FIG. 5 illustrates an example block diagram of a transparent touchscreen device. Transparent touchscreen device 120 includes a transparent touchscreen 122. Transparent touchscreen 122 may include any transparent device that enables viewing of a distant display through the transparent device while being able to determine touch input coordinates received upon the transparent device when the transparent device is touched. Such devices include transparent capacitive and resistive touchscreens as well transparent surface acoustic wave, infrared grid, optical imaging and acoustic pulse recognition devices and other devices known to those familiar with the art. Distant display locator 140 includes any device or process able to determine the location of the distant display, and in this example includes an at least one forward camera 142, which operates as described previously and produces spherical coordinates of the distant display relative to the transparent display device. The observer locator 150 includes any device or process for determining the location of the eye of the observer, and in this example includes at least one rearward camera 152 which operates as described previously and produces spherical coordinates of the location of the eye of the observer relative to the transparent display device. Line-of-sight determiner determines the line-of-sight between the observer and the distant display based upon the corresponding determined locations. Distant display zone module 520 determines if the determined line-of-sight passes through the transparent touchscreen, and if so, establishes at least one distant display zoned on the transparent touchscreen, the distant display zone having dimensions corresponding to either the distant display or an icon image as perceived by the observer.

Controller 530 controls the operation of the transparent touchscreen device and includes a processing circuit 532 and storage media 534 for storing instructions for execution by the processing circuit configured to perform the methods and processes described herein. Transformation module 540 transforms the transparent touchscreen touch input coordinates to distant display coordinates. The transformation may compensate for alignment issues between the distant display and the transparent touchscreen. The distant display coordinates are then transmitted by transceiver 170 which may be in communication with the distant display or other network or the Internet depending upon the example as previously explained above. Other distant display related processes 550 may also be impended. For example if the distant display corresponds to the non-interactive distant display of FIG. 1, then an additional distant display related process may include decoding a QR code to determine a URL or metadata related to QR code or other information on the distant display.

In one brief example of operation, upon detection of a touch input upon the transparent touchscreen, forward and rearward cameras capture forward and rearward images, which are processed to determine distant display and observer eye locations and then further processed determine the line-of-sight and the distant display zone on the transparent touchscreen. If the touch input is received within the distant display zone then the touch input coordinates are transformed from transparent touchscreen coordinates to distant display coordinates based upon the distant display zone and the distant display coordinates are transmitted.

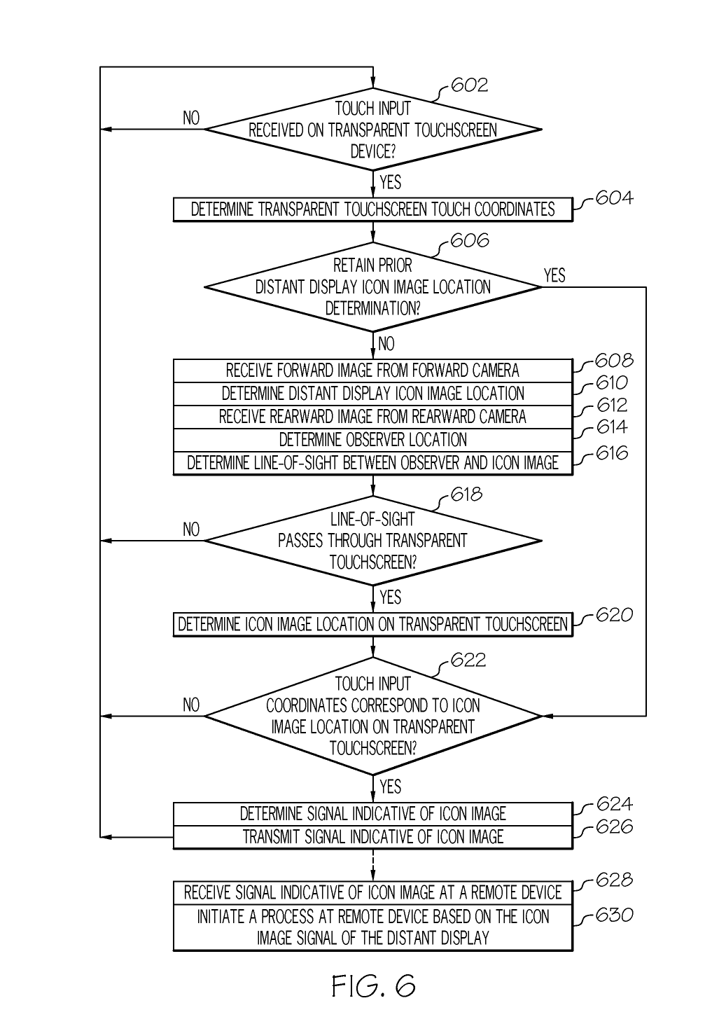

FIG. 6 illustrates an example of a flow diagram for a transparent touchscreen device operating with a non-interactive distant display. If a touch input is received at the transparent touchscreen at step 602, then step 604 determines the transparent touchscreen coordinates. Step 606 determines if the distant display zone indicative of the icon image previously determined is to be retained. This step allow an operator to retain a previously determined distant display zone or icon image location on the transparent touchscreen so that the icon images can be accessed again without requiring reestablishment of a line-of-sight between the observer, through the transparent touchscreen, and to the distant display. In this mode, if the distant display zone of the icon was last in the lower left of the transparent display, the observer could again initiate the process associated with the icon with a touch input at the lower left of the distant display even though the line-of-sight is not again established. This operation may be manually selectable. If not retained, step 608 receives a forward image from the forward camera and step 610 determines the distant display icon image location. Step 612 receives a rearward image from the rearward camera and step 614 determines the observer location. Step 616 determines the line-of-sight between the observer and the icon image. If the line-of-sight passes through the transparent touchscreen at step 618, then step 620 determines the icon image location on the transparent touchscreen based upon the determined line-of-sight. If the touch input coordinates on the transparent touchscreen correspond to the icon image location on the transparent touchscreen at step 622, then step 624 determines a signal indicative of the icon image. Step 626 then transmits the signal indicative of the icon image and the process in the transparent touchscreen device returns to step 602. In step 628, a remote device or application receives the signal indicative of the icon image. Step 630 then initiates a process at the remote device based on the icon image signal related to the distant display. For example, if the icon image was a “buy-it-now” image, as previously described, then the process of 630 would complete the purchase transaction and initiate shipping of a product. Note that the current invention pertains to transparent touch screens, but does not prevent one skilled in the art from displaying temporarily on the touch screen display indicators corresponding to the icon image signal related to the distant display, which may temporarily occlude in part a region of the transparent touch screen. This may be accomplished by integrating a transparent display with the transparent touchscreen.

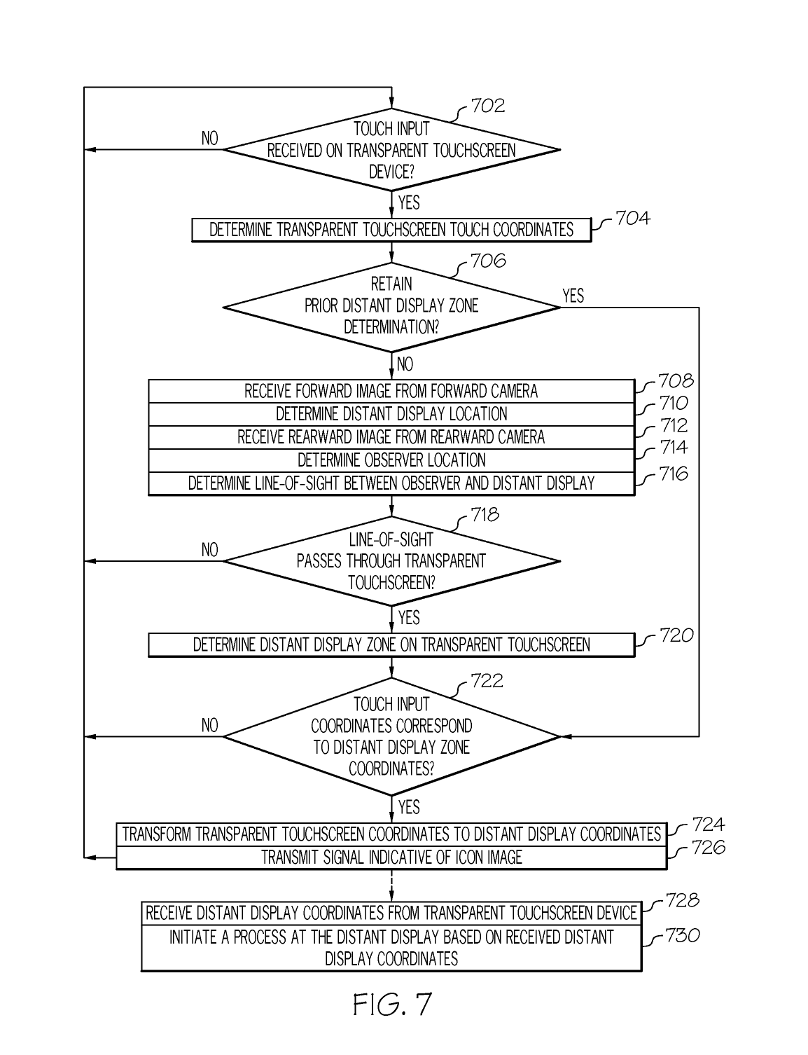

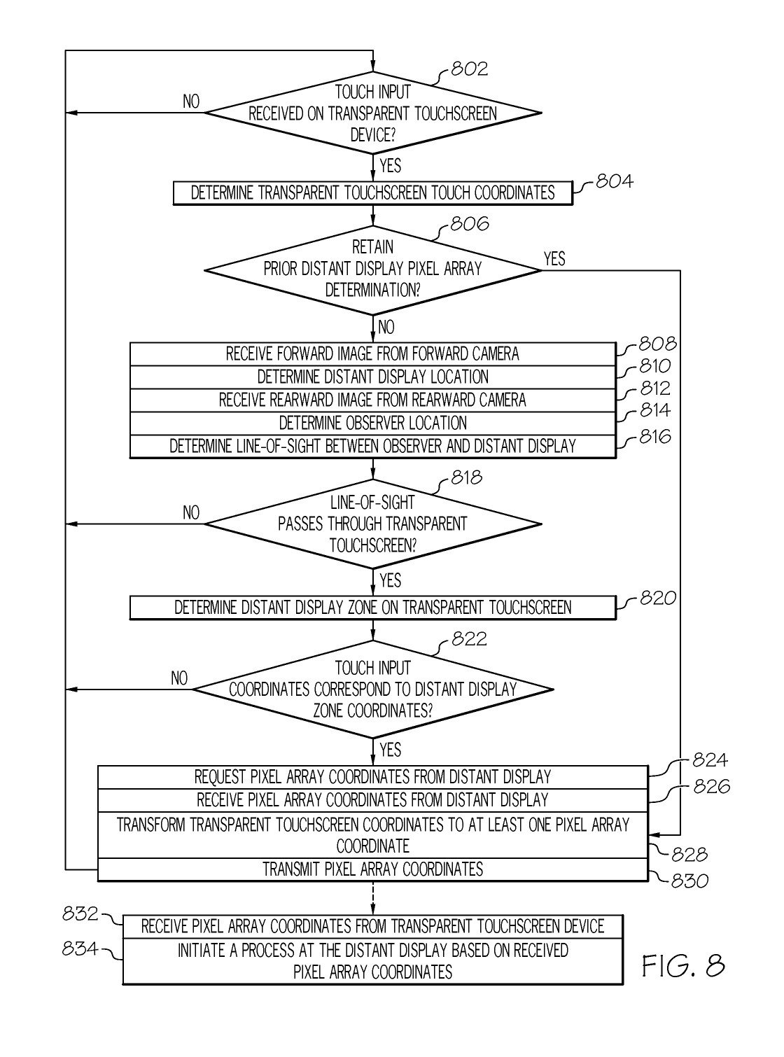

FIG. 7 illustrates an example of a flow diagram for a transparent touchscreen device operating with an interactive distant display using transformed distant display coordinates. If a touch input is received at the transparent touchscreen at step 702, then step 704 determines the transparent touchscreen coordinates of the touch input. Similar to step 606, step 706 determines if the prior distant display zone determination is to be retained. If not, similar to steps 608-618, steps 708-718 determine the line-of-sight between the observer and the distant display to pass through the transparent touchscreen. If determined, step 720 determines the distant display zone on the transparent touchscreen and step 722 determines if the touch input coordinates correspond to the distant display zone coordinates. If determined, step 724 transforms the transparent touchscreen coordinates to distant display coordinates, which are transmitted at step 726. Thereafter the process at the transparent display device returns to step 702. At the distant display device, the distant display coordinates are received from the transparent touchscreen device at step 728, and step 730 initiates a process at the distant display device based on the distant display coordinates. For example, if the touch input was received at a location of the icon of FIG. 4, then in the example above, the distant display device may render a new unlocking image at step 730.

FIG. 8 illustrates an example of a flow diagram for a transparent touchscreen device operating with an interactive distant display using pixel array distant display coordinates. Steps 802-822 correspond to steps 702-722 of FIG. 7. If the touch input coordinates correspond to the distant display zone coordinates at step 822, the step 824 requests pixel array coordinates from the distant display, which are received at step 826 as a pixel array signal, which may be received by the receiver portion of transceiver 170. The distant display may also send an icon image location signal indicative of an icon image location in order to facilitate establishment of an icon image zone within the distant display zone so that icon image processing of FIG. 6 may be performed in addition to or in place of the other steps of FIG. 8. Then step 828 transforms the transparent touchscreen coordinates to at least one pixel array coordinate, which is transmitted at step 830 as a pixel array signal. Thereafter, the process at the transparent display device returns to step 802. At step 832, the pixel array coordinates are received at the distant display from the transparent touchscreen device, and step 834 initiates a process at the distant display based upon the received pixel array coordinates.

The respective implementations of the present disclosure can be carried out in any appropriate mode, including hardware, software, firmware or combination thereof. Alternatively, it is possible to at least partially carry out the implementation of the present disclosure as computer software executed on one or more data processors and/or a digital signal processor. The components and modules or processes of the implementation of the present disclosure can be implemented physically, functionally and logically in any suitable manner. Indeed, the function can be realized in a single member or in a plurality of members, or as a part of other functional members. Thus, it is possible to implement the implementation of the present disclosure in a single member or distribute it physically and functionally between different members and a processor.

Computer program code for carrying out operations for aspects of the present disclosure may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present disclosure are described herein with reference to flowchart illustrations flow diagrams and/or block diagrams of methods, apparatus (systems) and computer program products according to implementations of the disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the computer or other programmable data processing apparatus, create means for implementing the functions/acts specified in the blocks of the flowchart illustrations and/or block diagrams.

These computer program instructions may also be stored in a computer readable medium that can direct a computer or other programmable data processing apparatus to function in a particular manner, such that the instructions stored in the computer readable medium produce an article of manufacture including instruction means which implement the functions/acts specified in the blocks of the flowchart illustrations and/or block diagrams.

The computer program instructions may also be loaded onto a computer or other programmable data processing apparatus to cause a series of operational steps to be performed on the computer or other programmable data processing apparatus to produce a computer implemented process such that the instructions which execute on the computer or other programmable apparatus provide processes for implementing the functions/acts specified in the blocks of the flowchart illustrations and/or block diagrams.

The present disclosure is described by use of detailed illustration of the implementations of the present disclosure, and these implementations are provided as examples and do not intend to limit the scope of the present disclosure. Although these implementations are described in the present disclosure, modifications and variations on these implementations will be apparent to those of ordinary skill in the art. Therefore, the above illustration of the exemplary implementations does not confine or restrict the present disclosure. Other changes, substitutions and modifications are also possible, without departing from the scope of the description and the appended claims.

What is claimed is:

1. A method comprising:
determining a line-of-sight between an observer and a distant display to pass through a device having a transparent touchscreen;
determining a distant display zone on the transparent touchscreen based upon the line-of-sight; and
initiating a distant display related process based upon a touch input being received within the distant display zone.

2. The method according to claim 1 wherein the initiated process comprises transmitting a touch signal indicative of the touch input.

3. The method of claim 1 wherein the initiated process comprises:
transforming a transparent touchscreen coordinate of the touch input to a distant display coordinate based upon the distant display zone; and
transmitting a touch signal indicative of the distant display coordinate.

4. The method according to claim 3 wherein the distant display includes an array of pixels for rendering a rendered image, the array of pixels having a corresponding array of pixel coordinates on the distant display wherein
the transforming, further based upon the array of pixel coordinates, transforms the transparent touchscreen coordinate to the distant display coordinate, the distant display coordinate including an at least one pixel coordinate of the array of pixel coordinates.

5. The method according to claim 4 further comprising receiving a pixel array signal indicative of the array of pixel coordinates.

6. The method according to claim 1 wherein the distant display includes an icon image positioned at an icon image location on the distant display wherein
the determining the distant display zone determines an icon image zone based the icon image location,
the initiating initiates the distant display related process based upon the touch input being received within the icon image zone, and the initiated process includes transmitting a touch signal indicative of the icon image.

7. The method according to claim 6 further comprising receiving an icon image signal indicative of the icon image location on the distant display.

8. The method according to claim 6 further comprising:
receiving, from a forward camera affixed to the device, a forward image including the icon image; and
determining the icon image location based upon the forward image.

9. The method according to claim 1 further comprising:
receiving, from a forward camera affixed to the device, a forward image including a distant display image; and
receiving, from a rearward camera affixed to the device, a rearward image including an observer image, wherein
the line-of-sign is determined based upon the forward image and the rearward image.

10. The method according to claim 1 further comprising:
determining a distant display location; and
determining an observer location, wherein
the line-of-sight is determined based upon the distant display location and the observer location.

11. The method according to claim 1 wherein the touch input includes a motion gesture,
the initiating initiates the distant display related process based upon the motion gesture being at least partially received within the distant display zone, and the initiated process includes
transforming a transparent touchscreen coordinate set of the motion gesture to a transformed distant display coordinate set based upon the distant display zone; and
transmitting a touch signal indicative of the distant display coordinate set.

12. The method according to claim 11 further comprising:
rendering, at the distant display, an unlocking image for entering an image based gesture password for unlocking additional functionality of the distant display, the observer able to perceive the line-of-sight view of the unlocking image through the transparent touchscreen, and
unlocking, at the distant display, the additional functionality based upon the transformed distant display coordinate set corresponding to the image based gesture password.

13. The method according to claim 1 wherein the determined distant zone display area on the transparent touchscreen is preserved upon the line-of-sight no longer being determined.

14. A device comprising:
a transparent touchscreen configured to receive a touch input;
an observer locator configured to determine an observer location;
a distant display locator configured to determine a distant display location;
a line-of-sight determining module configured to, based upon the observer location and the distant display location, determine that a line-of-sight between the observer location and the distant display location passes through the transparent touchscreen;
a distant display zone module configured to determine a distant display zone on the transparent touchscreen based upon the line-of-sight; and
a controller configured to initiate a distant display related process based upon the touch input being received within the distant display zone.

15. The device according to claim 14 wherein
the distant display locator includes a forward camera affixed to the device, the forward camera receiving a forward image including a distant display image wherein the distant display location is determined based upon the forward image,
the observer locator includes a rearward camera affixed to the device, the rearward camera receiving a rearward image including an observer image wherein the observer location is determined based upon the rearward image, the device further comprising:
a coordinate transformation module configured to transform a transparent touchscreen coordinate of the touch input to a distant display coordinate based upon the distant display zone; and
a transmitter configured to transmit a touch signal indicative of the distant display coordinate.

16. The device according to claim 15 wherein the distant display image includes an array of pixels for rendering a rendered image, the array of pixels having a corresponding array of pixel coordinates on the distant display, the device further comprising
a receiver configured to receive a pixel array signal indicative of the array of pixel coordinates, wherein
the coordinate transformation module is configured to transform the transparent touchscreen coordinate of the touch input to the distant display coordinate, the distant display coordinate including an at least one pixel coordinate of the array of pixel coordinates.

17. The device according to claim 15 wherein
the touch input includes a motion gesture having a transparent touchscreen coordinate set upon the transparent touchscreen, and
the coordinate transformation module is configured to transform the transparent touchscreen coordinate set of the touch input to a distant display coordinate set based upon the distant display zone, and
the transmitter is configured to transmit the touch signal indicative of the distant display coordinate set.

18. A computer program product comprising:
a storage medium readable by a processing circuit and storing instructions for execution by the processing circuit configured to perform a method comprising:
determining a line-of-sight between an observer and a distant display to pass through a device having a transparent touchscreen;
determining a distant display zone on the transparent touchscreen based upon the line-of-sight;
initiating a distant display related process based upon a touch input being received within the distant display zone.

19. The computer program according to claim 18 wherein the method further comprises:
transforming a transparent touchscreen coordinate of the touch input to a distant display coordinate based upon the distant display zone; and
transmitting a touch signal indicative of the distant display coordinate.

20. The computer program according to claim 18 wherein the method further comprises:
receiving, from a forward camera affixed to the device, a forward image including a distant display image; and
receiving, from a rearward camera affixed to the device, a rearward image including an observer image, wherein
the line-of-sign is determined based upon the forward image and the rearward image.
